(19) United States
(12) Patent Application Publication
(10) Pub. No.: US 2012/0155375 A1
(43) Pub. Date: Jun. 21, 2012

(54) Method and Apparatus for Header Compression in Network Relay Scenario

(75) Inventor: Lei Zhu, Beijing (CN)

(73) Assignee: HUAWEI TECHNOLOGIES CO., LTD., Shenzhen (CN)

(21) Appl. No.: 13/405,032

(22) Filed: Feb. 24, 2012

Related U.S. Application Data
(63) Continuation of application No. PCT/CN2010/076396, filed on Aug. 26, 2010.

(30) Foreign Application Priority Data
Aug. 26, 2009 (CN) 200910189676.9

(51) Int. Cl. H04B 7/14

(52) U.S. Cl. 370/315

(57) ABSTRACT

Embodiments of the present application disclose a method and an apparatus for header compression in a network relay scenario. The method includes: receiving, by a relay node, a first header-compressed data packet sent by user equipment or another relay node; encapsulating a transport protocol header for the first data packet and performing header compression for the header to form a second data packet; and sending the second data packet to an eNodeB or a next relay node in an uplink direction.

### CROSS-REFERENCE TO RELATED APPLICATIONS

This application is a continuation of International Application No. PCT/CN2010/076396, filed on Aug. 26, 2010, which claims priority to Chinese Patent Application No. 200910189676.9, filed on Aug. 26, 2009, both of which are hereby incorporated by reference in their entireties.

### FIELD OF THE APPLICATION

The present application relates to the mobile communication field, and in particular, to a method and an apparatus for header compression in a network relay scenario.

### BACKGROUND OF THE APPLICATION

The relay technology is used to increase the distribution density of stations and antennas by adding some new Relay stations (or relay node, RN) on the basis of the original stations. These newly-added relay nodes and the original eNodeB (donor eNodeB) are all connected in a wireless manner, and have no wired connection with the transmission network. Downlink data firstly arrives at the donor eNodeB, then is transmitted to a relay node, and the relay node transmits the downlink data to a terminal user, and the case of uplink data is conversely. By using this method, the distance between an antenna and the end user is shortened, and the link quality of a terminal may be improved, thereby increasing the spectrum efficiency and the user data rate of a system.

IPv6 adopts an address space of 128 bits, and obtains a mobile IPv6 mechanism through some extension headers, thereby implementing that an IP (Internet Protocol)-based device can seamlessly move among different radio cells. However, on the other hand, a large address space and extension headers increase the transmission overhead. Especially in case of a radio link, transmitting lengthy headers wastes much radio link bandwidth that has already been in shortage. Therefore, how to efficiently transmit IPv6 packets has become a key problem that has to be solved in mobile IP. One solution is to use a header compression technology. The header compression technology is hereinafter called header compression for short.

In the implementation of the present invention, the inventor finds that, at present, no technology can solve how to perform header compression in a network relay scenarios.

### SUMMARY OF THE APPLICATION

Embodiments of the present application provide a method and an apparatus for header compression in a network relay scenario, so that header compression can be performed in a network relay scenario.

An embodiment of the present application provides a method for header compression in a network relay scenario, which includes:

receiving, by a relay node, a first header-compressed data packet sent by user equipment or another relay node;

encapsulating a transport protocol header for the first data packet, and performing header compression for the header to form a second data packet; and

sending the second data packet to an eNodeB or a next relay node in an uplink direction.

In one aspect, the transport protocol used for encapsulating the transport protocol header includes: a tunneling protocol and a transport protocol for the tunneling protocol, wherein the tunneling protocol includes: GTP-U.

In another aspect, the encapsulating the transport protocol header for the first header-compressed data packet, and performing header compression for the transport protocol header, to form the second data packet include: decompressing a header of the first header-compressed data packet to obtain an IP/UDP/APP. header; encapsulating the decompressed first data packet with an IP/UDP/GTP-U header; and compressing the IP/UDP/APP. header by using an IP/UDP/APP. compression profile and compressing the IP/UDP/GTP-U header by using an IP/UDP/GTP-U compression profile to form the second data packet having two segments of compressed headers; compressing the IP/UDP/APP. header and the IP/UDP/GTP-U header to form the second data packet having one segment of compressed headers.

In another aspect, the method further includes receiving, by the relay node, a first ROHC parameter sent by the user equipment and used for the first data packet; and sending, by the relay node, a first PDCP parameter supported by the relay node to the user equipment, wherein the first PDCP parameter includes the first ROHC parameter; wherein the decompressing the header of the first header-compressed data packet includes: decompressing, by the relay node, the header of the first header-compressed data packet according to the first ROHC parameter; after the decompressing the header of the first header-compressed data packet, the method further includes: sending, by the relay node, a second ROHC parameter for the second data packet to the eNodeB, so that the eNodeB decompresses the header of the second data packet according to the second ROHC parameter, wherein the second ROHC parameter comprises a profile used by the relay node for compressing the header of the second data packet; and receiving, by the relay node, a second PDCP parameter sent by the eNodeB and supported by the eNodeB, wherein the second PDCP parameter comprises the second ROHC parameter.

In another aspect, if the second data packet having two segments of compressed headers is formed, the second ROHC parameter includes an IP/UDP/APP. compression profile and an IP/UDP/GTP-U compression profile; or if the second data packet having one segment of compressed headers is formed, the ROHC parameter includes: a compression profile corresponding to the IP/UDP/APP. header and the IP/UDP/GTP-U header.

In another aspect, the receiving, by the relay node, the first header-compressed data packet sent by the user equipment includes receiving, by the relay node, the first header-compressed data packet, which is sent by the user equipment and encapsulated with an IP/UDP/APP. header that has undergone header compression; and the encapsulating the transport protocol header for the first header-compressed data packet, and performing header compression for the transport protocol header include: encapsulating an IP/UDP/GTP-U header outside the IP/UDP/APP. header of the first header-compressed data packet, and performing header compression for the IP/UDP/GTP-U header.

In another aspect, the method further includes receiving, by the relay node, a third ROHC parameter sent by the user equipment and used for the first header-compressed data packet; forwarding, by the relay node, the third ROHC parameter to the eNodeB; sending, by the relay node, a fourth ROHC parameter for the second data packet to the eNodeB, so that the eNodeB decompresses the header of the second data packet according to the third ROHC parameter and the fourth ROHC parameter, wherein the fourth ROHC parameter comprises a profile used by the relay node for compressing the header of the second data packet; receiving, by the relay node, a PDCP parameter sent by the eNodeB and supported by the eNodeB, wherein the PDCP parameter comprises the third ROHC parameter and the fourth ROHC parameter; and forwarding, by the relay node, the PDCP parameter supported by the eNodeB to the user equipment.

In another aspect, the method further includes receiving, by the relay node, a fifth ROHC parameter sent by the user equipment and used for the first data packet; sending, by the relay node, a third PDCP parameter supported by the relay node to the user equipment, wherein the third PDCP parameter comprises the fifth ROHC parameter; forwarding, by the relay node, the fifth ROHC parameter to the eNodeB; sending, by the relay node, a sixth ROHC parameter for the second data packet to the eNodeB, so that the eNodeB decompresses the header of the second data packet according to the fifth ROHC parameter and the sixth ROHC parameter, wherein the sixth ROHC parameter comprises a profile used by the relay node for compressing the header of the second data packet; and receiving, by the relay node, a fourth PDCP parameter sent by the eNodeB and supported by the eNodeB, wherein the fourth PDCP parameter comprises the fifth ROHC parameter and the sixth ROHC parameter.

In another aspect, the fifth ROHC parameter includes: an IP/UDP/APP. compression profile; and the sixth ROHC parameter comprises: an IP/UDP/GTP-U compression profile.

In another aspect, the receiving, by the relay node, the first header-compressed data packet sent by another relay node includes: receiving, by the relay node, the first header-compressed data packet, which is sent by another relay node and encapsulated with an IP/UDP/APP. header and an IP/UDP/GTP-U header that have undergone header compression; the encapsulating the transport protocol header for the first header-compressed data packet, and performing header compression for the transport protocol header to form the second data packet include: decompressing the IP/UDP/APP. header and the IP/UDP/GTP-U header of the first header-compressed data packet; compressing the IP/UDP/APP. header by using an IP/UDP/APP. compression profile, and compressing the IP/UDP/GTP-U header by using an IP/UDP/GTP-U compression profile to form the second data packet having two segments of compressed headers, or compressing the IP/UDP/APP. header and the IP/UDP/GTP-U header to form the second data packet having one segment of compressed headers; or, decompressing the IP/UDP/GTP-U header of the first header-compressed data packet; and compressing the IP/UDP/GTP-U header by using the IP/UDP/GTP-U compression profile to form the second data packet having two segments of compressed headers, wherein the two segments of compressed headers comprise: the IP/UDP/APP. header and the IP/UDP/GTP-U header.

In another aspect, the receiving, by the relay node, the first header-compressed data packet sent by the user equipment includes: receiving multiple first header-compressed data packets sent by multiple user equipment; the encapsulating the transport protocol header for the first header-compressed data packet, and performing header compression for the transport protocol header to form the second data packet include: encapsulating a same transport protocol header for the headers of the multiple first header-compressed data packets, and performing header compression for the transport protocol header to form a second data packet.

In another aspect, the second data packet is encapsulated with IP addresses and/or port numbers, wherein the IP addresses and/or port numbers are corresponding respectively to the multiple user equipment and for distinguishing data packets that are sent by the multiple user equipment and encapsulated with the same transport protocol header.

An embodiment of the present application provides a relay node, which includes:

a receiving unit, configured to receive a first header-compressed data packet sent by user equipment or another relay node;

an encapsulating and compressing unit, configured to encapsulate a transport protocol header for the first header-compressed data packet, and perform header compression for the transport protocol header to form a second data packet; and

a sending unit, configured to send the second data packet to an eNodeB or a next relay node in an uplink direction.

In one aspect, the encapsulating and compressing unit is configured to: decompress a header of the first data packet to obtain an Internet Protocol/User Datagram Protocol/Application Protocol, IP/UDP/APP., header, encapsulate the decompressed header of the first header-compressed data packet with an Internet Protocol/User Datagram Protocol/General Packet Radio Service Tunneling Protocol-User Plane, IP/UDP/GTP-U, header; and compress the IP/UDP/APP. header by using an IP/UDP/APP. compression profile and compress the IP/UDP/GTP-U header by using an IP/UDP/GTP-U compression profile to form the second data packet having two segments of compressed headers; or compress the IP/UDP/APP. header and the IP/UDP/GTP-U header to form the second data packet having one segment of compressed headers.

In other aspect, the encapsulating and compressing unit is configured to: encapsulate an IP/UDP/GTP-U header outside an IP/UDP/APP. header of the first header-compressed data packet to form the second data packet, and performing header compression for the IP/UDP/GTP-U header. Compared with the prior art, one of the foregoing technical solutions has following advantages or beneficial effects:

In the embodiments of the present invention, the relay node receives the first header-compressed data packet sent by the user equipment or another relay node; encapsulates the transport protocol header for the first data packet, and performs header compression for the header to form the second data packet; and sends the second data packet to the eNodeB or a next relay node in the uplink direction. Thereby, the header compression function is implemented; the occupation of air interface bandwidth is reduced; and the spectrum utilization is improved.

### BRIEF DESCRIPTION OF THE DRAWINGS

FIG. 1 is a flow chart of a method for header compression in a network relay scenario according to an embodiment of the present invention;

FIG. 2 is an architecture diagram of a user plane protocol stack of a relay node and a Donor eNodeB in a typical Relay scenario;

FIG. 3a is a schematic diagram of a method for header compression in a network relay scenario according to an embodiment of the present invention;

FIG. 3b is a frame structure of an IP header compressed between a UE and a relay node in the embodiment corresponding to FIG. 3a;

FIG. 3c is a frame structure of an IP header compressed between a relay node and an eNodeB in the embodiment corresponding to FIG. 3a;

FIG. 3d is a schematic diagram of a configuration process of compression parameters necessary in the embodiment corresponding to FIG. 3a;

FIG. 4a is a schematic diagram of another method for header compression in a network relay scenario according to an embodiment of the present invention;

FIG. 4b is a frame structure of an IP header compressed between a UE and a relay node in the embodiment corresponding to FIG. 4a;

FIG. 4c is a frame structure of an IP header compressed between a relay node and an eNodeB in the embodiment corresponding to FIG. 4a;

FIG. 4d is a schematic diagram of a configuration process of compression parameters necessary in the embodiment corresponding to FIG. 4a;

FIG. 4e is a schematic diagram of another configuration process of compression parameters necessary in the embodiment corresponding to FIG. 4a;

FIG. 5a is a schematic diagram of still another method for header compression in a network relay scenario according to an embodiment of the present invention;

FIG. 5b is a frame structure of an IP header compressed between a UE and a relay node in the embodiment corresponding to FIG. 5a;

FIG. 5c is a frame structure of an IP header compressed between a relay node and an eNodeB in the embodiment corresponding to FIG. 5a;

FIG. 5d is a schematic diagram of a configuration process of compression parameters necessary in the embodiment corresponding to FIG. 5a;

FIG. 6a is a schematic diagram of still another method for header compression in a network relay scenario according to an embodiment of the present invention;

FIG. 6b is a frame structure of an IP header compressed between a UE and a relay node in the embodiment corresponding to FIG. 6a;

FIG. 6c is a frame structure of an IP header compressed between a relay node and an eNodeB in the embodiment corresponding to FIG. 6a;

FIG. 7a is a schematic diagram of still another method for header compression in a network relay scenario according to an embodiment of the present invention;

FIG. 7b is a frame structure of an IP header compressed between a UE and relay node 1 in the embodiment corresponding to FIG. 7a;

FIG. 7c is a frame structure of an IP header compressed between relay node 1 and relay node 2 in the embodiment corresponding to FIG. 7a;

FIG. 7d is a frame structure of an IP header compressed between relay node 2 and an eNodeB in the embodiment corresponding to FIG. 7a;

FIG. 8 is a schematic diagram of still another method for header compression in a network relay scenario according to an embodiment of the present invention;

FIG. 9a is a schematic diagram of a frame structure of a UDP packet;

FIG. 9b is a schematic diagram of a frame structure of IPv4;

FIG. 9c is a schematic diagram of a frame structure of IPv6; and

FIG. 10 is a schematic structure diagram of a relay node according to an embodiment of the present invention.

### DETAILED DESCRIPTION OF THE EMBODIMENTS

To make the objectives, the technical solutions, and the advantages of the embodiments of the present application clearer, the embodiments of the present application are described in detail below with reference to the accompanying drawings.

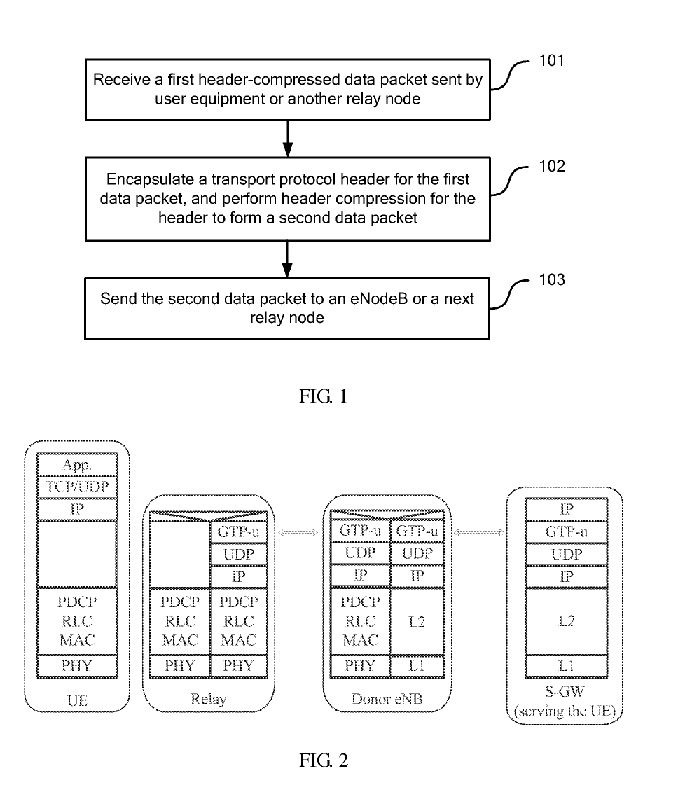

FIG. 1 is a flow chart of a method for header compression in a network relay scenario according to an embodiment of the present invention, which includes the following:

101. Receive a first header-compressed data packet sent by user equipment or another relay node.

102. Encapsulate a transport protocol header for the first data packet, and perform header compression for the header to form a second data packet.

The transport protocol specifically includes: a tunneling protocol and a transport protocol for the tunneling protocol. The tunneling protocol includes: GTP-U (GPRS Tunneling Protocol-User plane, general packet radio service tunneling protocol-user plane). An IP/UDP (user datagram protocol) protocol header is encapsulated in the GTP-U tunneling protocol. The IP protocol and the UDP protocol are used for bearing the tunneling protocol.

Specifically, step 102 may be performed as follows:

after decompressing the header of the first data packet, compressing the decompressed header of the first data packet by using an IP/UDP/APP. compression profile and an IP/UDP/GTP-U compression profile respectively to respectively form the second data packet having two segments of compressed headers; or compressing the IP/UDP/APP. header and the IP/UDP/GTP-U header into one segment of compressed headers to form the second data packet.

Alternatively, step 102 may be: encapsulating the IP/UDP/GTP-U header outside the IP/UDP/APP. header of the first header-compressed data packet, to form the second data packet.

103. Send the second data packet to an eNodeB or a next relay node.

Through the method provided in this embodiment, under the circumstance where there is a relay node between the UE and the network and the interface between the relay node and the network is still a radio interface, the relay node performs header compression for the data packet between the relay node and the UE, and performs header compression for the data packet between the relay node and the eNodeB entity respectively. Thereby, the problem that the data packets occupy too much bandwidth in a network relay scenario is solved; and by applying header compression on the relay node, the eNB, and the UE, the occupation of air interface bandwidth is reduced, and the spectrum utilization is improved.

The method provided in this embodiment of the present application is described below with reference to a specific Relay scenario. It should be particularly noted that, this embodiment of the present application may also be applied in other Relay scenarios.

FIG. 2 shows an architecture of a user plane protocol stack of a relay node and a Donor eNodeB in a typical Relay scenario, which involves: App. (application protocol), TCP (transfer control protocol), UDP, PDCP (packet data convergence protocol), RLC (radio link control protocol), MAC (media access control), PHY (physical layer), GTP-U, and so on, where App. (application protocol) specifically includes: RTP (realtime transport protocol), HTTP (hypertext transfer protocol) or FTP (file transfer protocol), and so on. In the present invention, IP/UDP/APP. represents a combination form of an application protocol and transport protocol of the application protocol. In the present invention, there are also combinations of other application protocols and IP, TCP, and UDP, and, such combinations are also applicable to the present invention.

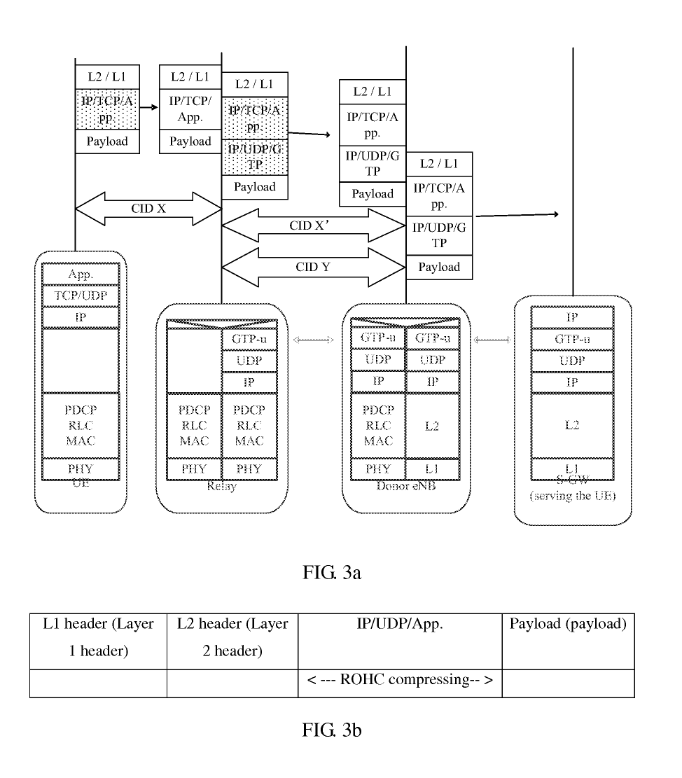

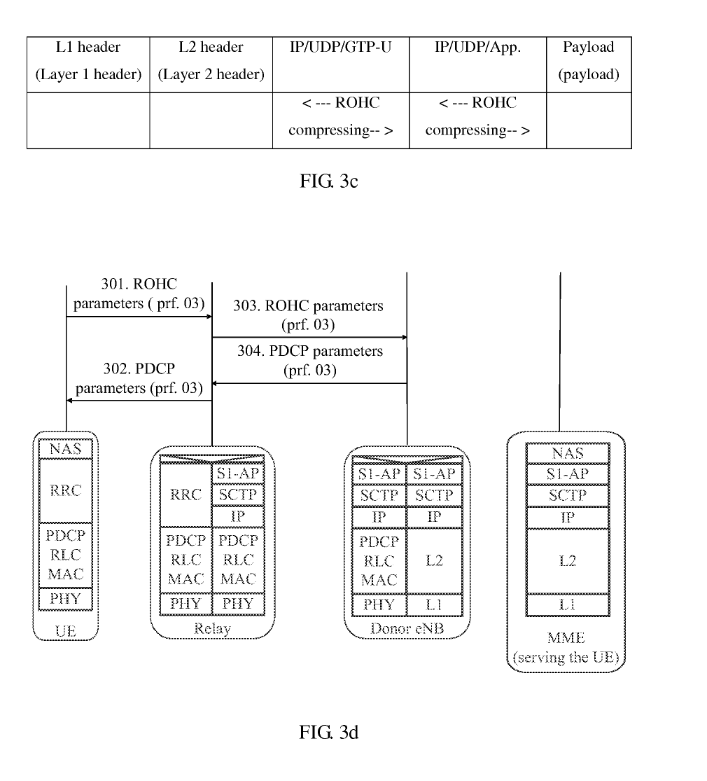

FIG. 3a is a schematic diagram of a method for header compression in a network relay scenario according to an embodiment of the present invention. In order to clearly distinguish a compressed part from a decompressed part, the dotted shade is used in the drawing to represent a compressed part. CID represents a context identifier. Because multiple contexts may be maintained in one bearer, it is necessary to use context identifiers to distinguish different header compression processes with respect to one media stream. In the ROHC protocol, the CID is a binary number of 0 to 15 digits. In this embodiment of the present invention, CID X represents that a header compression context for the IP/UDP/APP. header, which is identified by a Context Identifier X, is established between the UE and the relay node; CID X′ represents that a header compression context for the IP/UDP/APP. header, which is identified by a Context Identifier X′, is established between the relay node and the eNodeB; and CID Y represents that a header compression context for the IP/UDP/GTP-U header, which is identified by a Context Identifier Y, is established between the relay node and the eNodeB. CID X, CID X′ and CID Y represent different context identifiers respectively.

In this embodiment, the media sent by the UE (user equipment) is compressed on the user plane by using a header compression profile and is decompressed on the relay node. On the relay node, the user plane data sent to the donor eNodeB entity is compressed by using an IP/UDP/APP. compression profile and an IP/UDP/GTP-U compression profile respectively; and the eNodeB entity decompresses the IP header, and sends the decompressed data packet to a next network entity, such as a serving gateway, or a public data network gateway (PDN GATEWAY). IP/UDP/APP. represents the protocol stack that is being used by the UE from the IP protocol to the application layer protocol for the service, such as IP/UDP/RTP; a protocol stack is a fixed combination of some protocols, such as IP/TCP/HTTP, IP/TCP, IP, and UDP. The meaning of this expression in other embodiments of the present application is the same as above and thus is not repeated here again. The Donor eNodeB is a primary eNodeB that provides signals for Relay nodes and is hereinafter called an eNodeB for short.

In this embodiment, a context for a compression profile for compressing the IP/UDP/APP. header is established between the UE and the relay node, and a context for a compression profile for the IP/UDP/GTP-U header is established between the relay node and the eNodeB.

A frame structure of a compressed IP header for which a context for ROHC compressing is established between the UE and the relay node is as shown in FIG. 3b.

A frame structure of a compressed IP header for which a context for two nested layers of ROHC compression is established between the relay node and the eNodeB is as shown in FIG. 3c.

FIG. 3d shows a configuration process of compression parameters necessary during the compression in this embodiment, which is also called a negotiation process, involving RRC (radio resource control protocol), S1-AP (S1 interface), SCTP (stream control transport protocol), and NAS (non-access stratum). At this time, the relay node acts as a terminal, and the S1-AP interface may also be used to negotiate the header compression parameters. Specifically, the configuration process specifically includes the following:

301. The UE sends a DRB (dedicated radio bearer) establishment/configuration message, which includes ROHC parameters. The ROHC parameters sent at this time include a compression mechanism, such as ROHC compression, and a profile of the compressed header, such as IP/UDP/APP. At this time, the profile of ROHC compression supported by the UE is a separate IP/UDP/App. compression profile, an IP/TCP compression profile, an IP/UDP compression profile, and so on. The PDCP parameter represents the UE's capability to support header compression. The profile of the compressed header is a compression profile of the compression mechanism with respect to a certain type of header combination. In FIG. 3d, prf.03 (profile 03) represents an identifier of a fixed compression profile for performing the header compression, for example, if the ROHC parameters sent by the UE include Profile 0x0001, which represents that the UE requests ROHC compression supporting Profile 0x0001 on the established DRB.

302. After receiving the ROHC parameters sent by the UE, such as the ROHC compression, and the profile of the compressed header, the relay node may send a reconfiguration message to the UE, where the network reconfiguration message includes PDCP parameters, and the PDCP parameters include ROHC compression parameters that are reconfigured for the DRB and supported by the DRB and the profile of the compressed header. The frame structure of the compressed IP header is as shown in FIG. 3b.

It should be noted that, step 302 may follow step 301 or may be performed after the relay node completes step 303 in the procedure.

This procedure may establish a context for the ROHC compression between the UE and the relay node.

303. In order for the relay node to perform the header compression mechanism between the relay node and the air interface of the eNodeB entity, the user plane data sent between the relay node and the eNodeB further includes the IP/UDP/GTP-U header in addition to a payload, an L1 header (layer 1 header) and an L2 header (layer 2 header), and the IP/UDP/APP. header as shown in the drawing. In this embodiment, in addition to the IP/UDP/APP. header received by the relay node, the IP/UDP/GTP-U header also needs to be compressed.

The relay node sends the eNodeB the supported ROHC parameters. The ROUC parameters sent at this time includes a compression mechanism, such as ROHC compression, and the profile of the compressed header, where the compression profile here respectively includes an identifier of the IP/UDP/GTP-U compression profile and a support of the IP/UDP/APP. compression profile, which indicates that the relay node supports and requests the application of the IP/UDP/GTP-U compression and the IP/UDP/APP. compression respectively in the requested DRB.

304. After receiving the ROHC parameters such as the ROHC compression and the identifier of the IP/UDP/GTP-U compression profile and the IP/UDP/APP. compression profile of the compressed header, the eNodeB may send a reconfiguration message to the relay node, where the network reconfiguration message includes PDCP parameters, and the PDCP parameters include ROHC compression parameters reconfigured for the DRB and supported by the DRB and the identifier of the IP/UDP/GTP-U compression profile and the IP/UDP/APP. compression profile of the compressed header. The frame structure of the compressed IP header is as shown in FIG. 3c.

This procedure may establish a context for two nested layers of ROHC compression between the eNodeB and the relay node.

In this embodiment, because of the existence of the relay node, air interface transmission occurs twice in the transmission between the UE and the eNodeB entity, and the two nested layers of ROHC compression may solve the problem of the header compression mechanism in different protocol stacks, save resources of two air interfaces, reduce the air interface load, and improve the spectrum utilization.

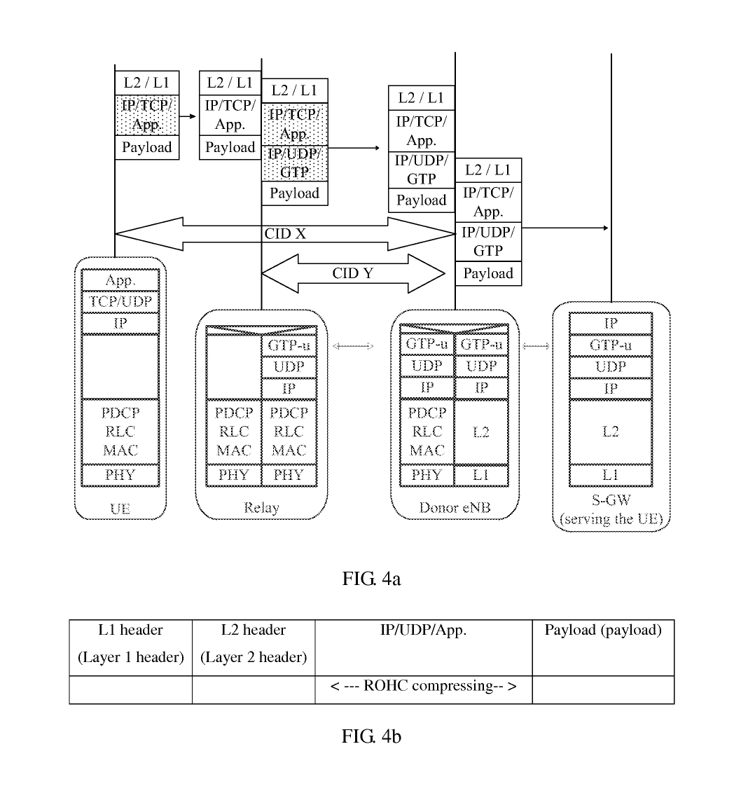

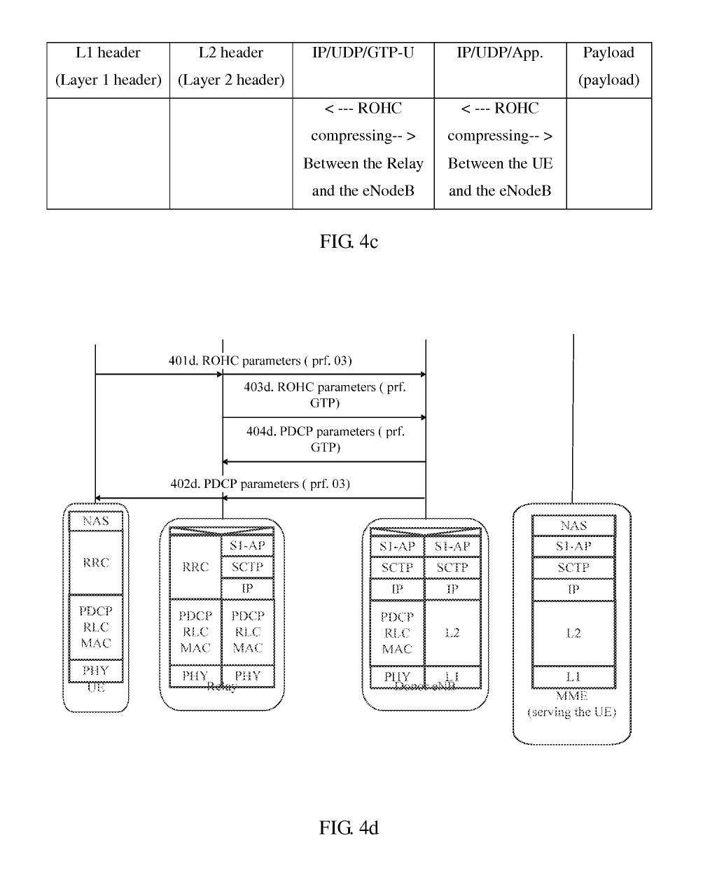

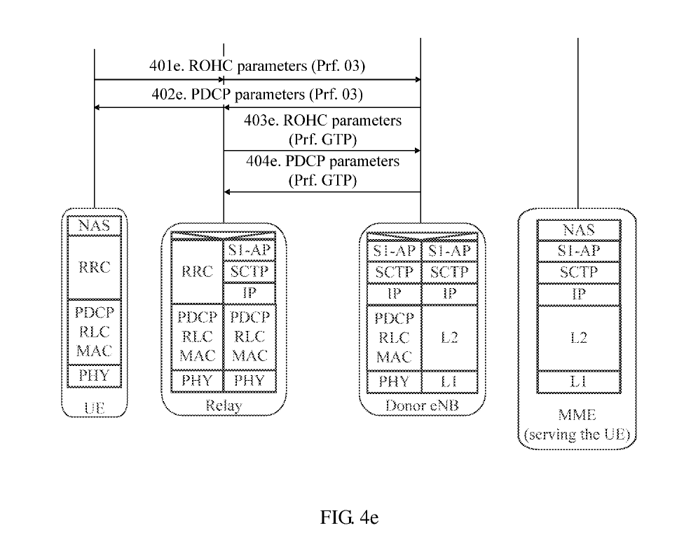

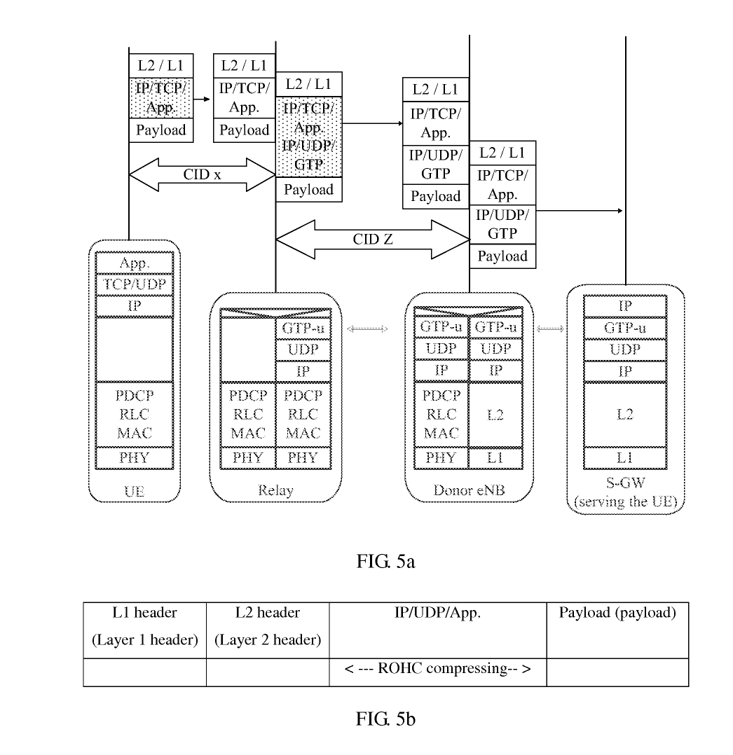

FIG. 4a is a schematic diagram of another method for header compression in a network relay scenario according to an embodiment of the present invention. In order to clearly distinguish a compressed part from a decompressed part, the dotted shade is used in the drawing to represent a compressed part.

In this embodiment, the media sent by the UE is compressed on the user plane by using the IP/UDP/App. header compression profile, and the relay node does not decompress the compressed IP/UDP/App. header but sends the compressed IP/UDP/App. header to the eNodeB entity.

The relay node receives a compressed data packet, encapsulates an IP/UDP/GTP-U header outside the header of the packet, where header compression may be performed for the IP/UDP/GTP-U header, and sends the packet to the eNodeB entity. The eNodeB entity decompresses the received and respectively compressed IP/UDP/GTP-U header and IP/UDP/App. header respectively, and sends the decompressed headers to a next network entity.

In this embodiment, no compression context is established between the UE and the relay node; a context for the compression profile of the IP/UDP/GTP-U header is established between the relay node and the eNodeB; and a context for the compression profile of the IP/UDP/App. header is established between the UE and the eNodeB.

The frame structure of the compressed IP header transmitted between the UE and the relay node is as shown in FIG. 4b. The compressed IP/UDP/App. header and the Payload portion of the IP packet of this frame structure are sent by the relay node directly to the eNodeB entity.

The frame structure of the compressed IP header for which a context for two nested layers of ROHC compression is established between the relay node and the eNodeB is as shown in FIG. 4c, where the IP/UDP/App. header is the header compressed by the UE entity and directly forwarded by the relay node, and the IP/UDP/GTP-U header is the header encapsulated by the relay node.

During the compression in the foregoing embodiment, a context for ROHC compression that supports the IP/UDP/APP. compression profile is established between the UE and the eNodeB, the relay node sends the received IP/UDP/APP. compressed header after the ROHC compression to the eNodeB entity directly, and the eNodeB entity is responsible for decompressing the IP/UDP/APP. compressed header; meanwhile, in the data packet sent to the eNodeB, the relay node adds the IP/UDP/GTP-U header, and performs the IP/UDP/GTP-U compression profile.

FIG. 4d shows a case of a configuration process of compression parameters necessary during the compression in this embodiment, which specifically includes the following:

401d: The UE sends a DRB establishment/configuration message, which includes ROHC parameters. The ROHC parameters sent at this time include a compression mechanism, such as ROHC compression, and a profile of the compressed header, such as IP/UDP/APP. At this time, the profile of ROHC compression supported by the UE is a separate IP/UDP/APP. compression profile, an IP/TCP compression profile, an IP/UDP compression profile, and so on. The PDCP parameter represents the UE's capability to support header compression. The profile of the compressed header is a compression profile of the compression mechanism with respect to a certain type of header combination.

402d: After the relay node receives the ROHC parameters sent by the UE, such as the ROHC compression, and the profile of the compressed header, in order to perform the header compression mechanism between the relay node and the air interface of the eNodeB entity, the relay node sends the received ROHC parameters to the eNodeB entity, where the ROHC parameters include the ROHC compression parameters requested by the UE and supported by the DRB, and the profile of the compressed header.

In order for the relay node to perform the header compression mechanism between the relay node and the air interface of the eNodeB entity, the user plane data sent between the relay node and the eNodeB further includes the IP/UDP/GTP-U header in addition to a payload, a Layer 1 header and a Layer 2 header, and the compressed IP/UDP/APP. header received by the relay node. In this embodiment, the IP/UDP/GTP-U header also needs to be compressed.

The supported ROHC parameters sent by the relay node to the eNodeB include an identifier of the IP/UDP/GTP-U compression profile, which indicates that the relay node supports and requests the application of the IP/UDP/GTP-U compression, and the IP/UDP/APP. compression requested by the UE respectively in the requested DRB.

403d: After receiving the ROHC parameters such as the ROHC compression and the identifier of the IP/UDP/GTP-U compression profile and the IP/UDP/APP. compression profile of the compressed header, the eNodeB may send a reconfiguration message to the relay node, where the network reconfiguration message includes PDCP parameters, and the PDCP parameters include ROHC compression parameters reconfigured for the DRB and supported by the DRB and the identifier of the IP/UDP/GTP-U compression profile and the IP/UDP/APP. compression profile of the compressed header.

404d: The relay node sends the PDCP parameters to the UE, and may send a reconfiguration message to the UE, where the network reconfiguration message includes the PDCP parameters, and the PDCP parameters include ROHC compression parameters reconfigured for the DRB and supported by the DRB, and the profile of the compressed header. The frame structure of the compressed IP header is as shown in FIG. 4c.

This procedure may establish a context for two nested layers of ROHC compression between the UE, the relay node, and the eNodeB.

FIG. 4e shows another case of a configuration process of compression parameters necessary during the compression in this embodiment, which specifically includes the following:

401e: The UE sends a DRB establishment/configuration message that includes ROHC parameters. The ROHC parameters sent at this time include a compression mechanism, such as ROHC compression, and a profile of the compressed header, such as IP/UDP/APP. At this time, the profile of ROHC compression supported by the UE is a separate IP/UDP/APP. compression profile, an IP/TCP compression profile, an IP/UDP compression profile, and so on. The PDCP parameter represents the UE's capability to support header compression. The profile of the compressed header is a compression profile of the compression mechanism with respect to a certain type of header combination.

402e: The relay node sends PDCP parameters to the UE, and may send a reconfiguration message to the UE, where the network reconfiguration message includes PDCP parameters, and the PDCP parameters include ROHC compression parameters reconfigured for the DRB and supported by the DRB, and the profile of the compressed header. The frame structure of the compressed IP header is as shown in FIG. 4c.

403e: After receiving the ROHC parameters sent by the UE, such as the ROHC compression, and the profile of the compressed header, the relay node may use these parameters for performing the header compression mechanism between the relay node and the air interface of the eNodeB entity, and sends the received ROHC parameters sent by the UE to the eNodeB entity, where the ROHC parameters include the ROHC compression parameters requested by the UE and supported by the DRB, and the profile of the compressed header.

In order for the relay node to perform the header compression mechanism between the relay node and the air interface of the eNodeB entity, the user plane data sent between the relay node and the eNodeB further includes the IP/UDP/GTP-U header in addition to a payload, a Layer 1 header and a Layer 2 header, and the compressed IP/UDP/APP. header received by the relay node. In this embodiment, the IP/UDP/GTP-U header also needs to be compressed.

When the relay node sends the ROHC parameters received from the UE to the eNodeB entity, the relay node sends the eNodeB the supported ROHC parameters, including an identifier of the IP/UDP/GTP-U compression profile, which indicates that the relay node supports and requests the application of the IP/UDP/GTP-U compression, and the IP/UDP/APP. compression requested by the UE respectively, in the requested DRB.

404e: After receiving the ROHC parameters such as the ROHC compression and the identifier of the IP/UDP/GTP-U compression profile and the IP/UDP/APP. compression profile of the compressed header, the eNodeB may send a reconfiguration message to the relay node, where the network reconfiguration message may include PDCP parameters, and the PDCP parameters include ROHC compression parameters reconfigured for the DRB and supported by the DRB and the identifier of the IP/UDP/GTP-U compression profile and the IP/UDP/APP. compression profile of the compressed header.

This procedure may establish a context for two nested layers of ROHC compression between the UE, the relay node, and the eNodeB.

The embodiments corresponding to FIG. 4a to FIG. 4e provide a method for a relay node to compress a header and two methods for configuring compression parameters. Thereby, the problem that the IP packets occupy too much bandwidth in a network relay scenario is solved, and by applying the ROHC compression mechanism on the relay node, the eNB, and the UE, the function of compressing an IP header is solved and implemented; the occupation of air interface bandwidth is reduced; and the spectrum utilization is improved.

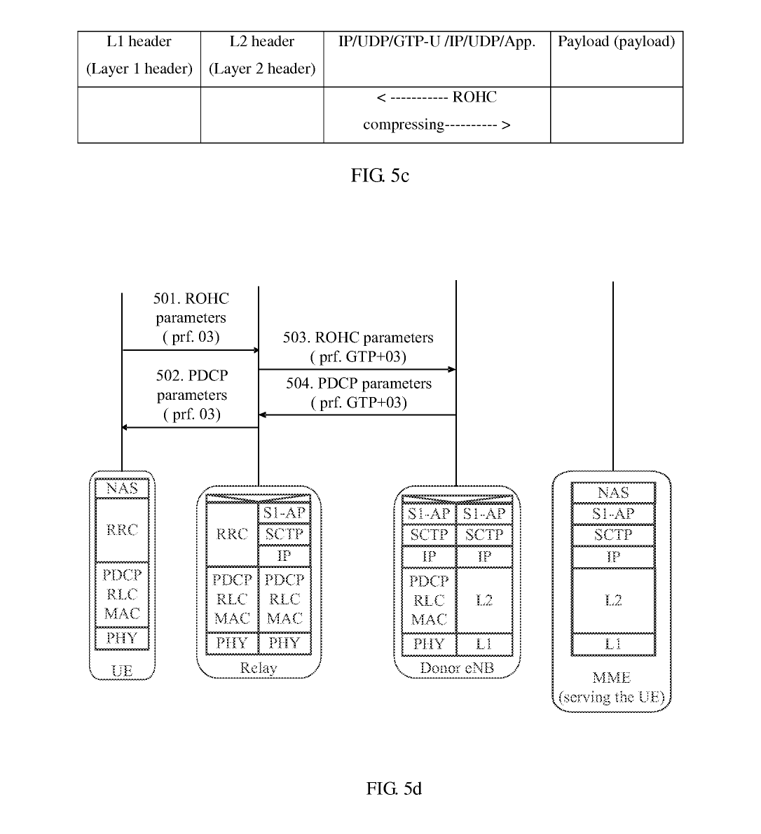

FIG. 5a is a schematic diagram of another method for header compression in a network relay scenario according to an embodiment of the present invention. In order to clearly distinguish a compressed part from a decompressed part, the dotted shade is used in the drawing to represent a compressed part.

In this embodiment, the media sent by the UE is compressed on the user plane by using a header compression profile and is decompressed on the relay node. The user plane data sent by the relay node to the eNodeB entity is compressed by using the IP/UDP/APP. and IP/UDP/GTP-U header compression profiles, and the eNodeB entity decompresses the IP header and sends the decompressed data packet to a next entity.

In this embodiment, a context for a compression profile for compressing an IP/UDP/APP. header is established between the UE and the relay node, and a context for a compression profile for an IP/UDP/APP. header and an IP/UDP/GTP-U header is established between the relay node and the eNodeB.

A frame structure of a compressed IP header for which a context for ROHC compression is established between the UE and the relay node is as shown in FIG. 5b.

A frame structure of a compressed IP header for which a context for the ROHC compression of the IP/UDP/APP. and IP/UDP/GTP-U headers is established between the relay node and the eNodeB is as shown in FIG. 5c.

FIG. 5d shows a configuration process of compression parameters necessary during the compression in this embodiment, which is also called a negotiation process, and specifically includes the following:

501: The UE sends a DRB establishment/configuration message that includes ROHC parameters. The ROHC parameters sent at this time include a compression mechanism, such as ROHC compression, and a profile of the compressed header, such as IP/UDP/APP. At this time, the profile of ROHC compression supported by the UE is a separate IP/UDP/App. compression profile, an IP/TCP compression profile, an IP/UDP compression profile, and so on. The PDCP parameter represents the UE's capability to support header compression. The profile of the compressed header is a compression profile of the compression mechanism with respect to a certain type of header combination.

502: After receiving the ROHC parameters sent by the UE, such as the ROHC compression, and the profile of the compressed header, the relay node may send a reconfiguration message to the UE, where the network reconfiguration message includes PDCP parameters, and the PDCP parameters include ROHC compression parameters reconfigured for the DRB and supported by the DRB and the profile of the compressed header. The frame structure of the compressed IP header is as shown in FIG. 5b.

It should be noted that, step 502 may follow step 501 or may be performed after the relay node completes step 503 in the procedure.

This procedure may establish a context for the ROHC compression between the UE and the relay node.

503: In order for the relay node to perform the header compression mechanism between the relay node and the air interface of the eNodeB entity, the user plane data sent between the relay node and the eNodeB further includes the IP/UDP/GTP-U header in addition to a payload, a Layer 1 header and a Layer 2 header, and the IP/UDP/APP. header as shown in the drawing. In the foregoing embodiment, in addition to the IP/UDP/APP. header received by the relay node, the IP/UDP/GTP-U header is also compressed at the same time.

The relay node sends the eNodeB the supported ROHC parameters including a compression mechanism, such as ROHC compression, and the profile of the compressed header, where the compression profile here includes an indication of a compression profile for compressing the IP/UDP/GTP-U and IP/UDP/APP. headers, which indicates that the relay node supports and requests the application of the IP/UDP/GTP-U and IP/UDP/APP. compression profiles in the requested DRB.

504: After receiving the ROHC parameters such as the ROHC compression and the IP/UDP/GTP-U and IP/UDP/APP. compression profiles of the compressed header, the eNodeB may send a reconfiguration message to the relay node, where the network reconfiguration message includes PDCP parameters, and the PDCP parameters include ROHC compression parameters reconfigured for the DRB and supported by the DRB and the IP/UDP/GTP-U and IP/UDP/APP. compression profiles of the compressed header. The frame structure of the compressed IP header is as shown in FIG. 5c; this procedure may establish a context for two nested layers of ROHC compression between the eNodeB and the relay node.

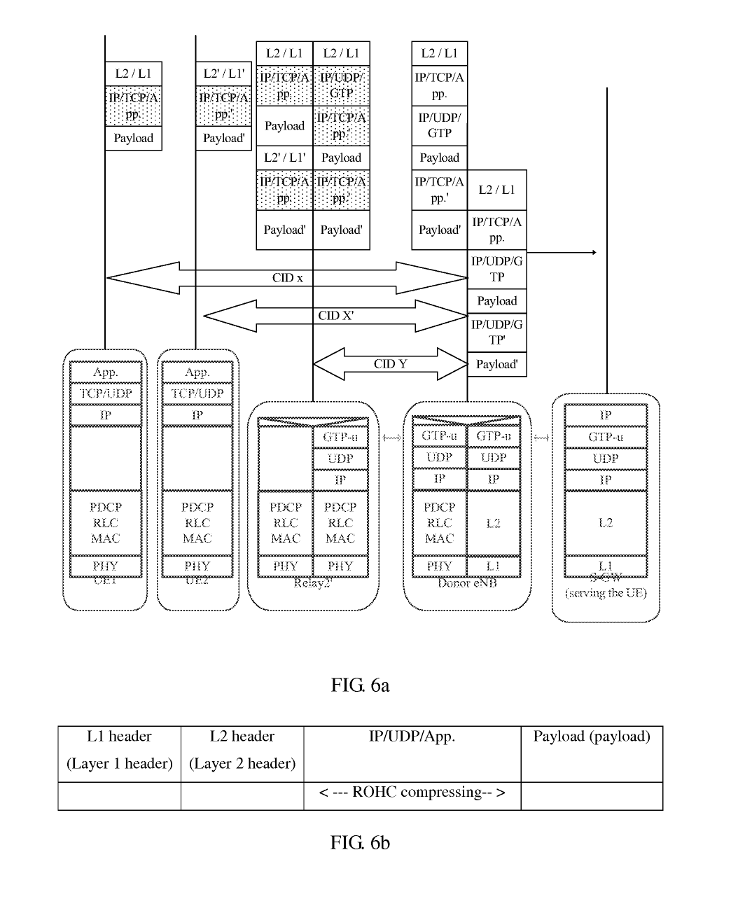

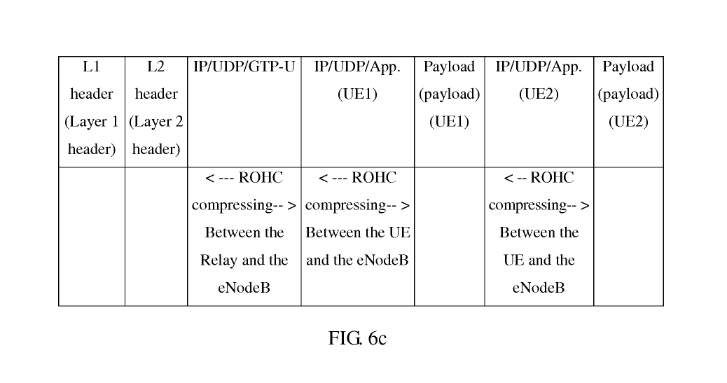

FIG. 6a is a schematic diagram of another method for header compression in a network relay scenario according to an embodiment of the present invention. In order to clearly distinguish a compressed part from a decompressed part, the dotted shade is used in the drawing to represent a compressed part.

In this embodiment, header compression for the IP/UDP/App. header is performed between the UE and the relay node with respect to the data sent by multiple UEs. For the data sent by the relay node to the eNodeB, the IP headers sent by the multiple UEs are encapsulated by using a same IP/UDP/GTP-U header, and the header compression profile of the IP/UDP/GTP-U header is performed.

In this embodiment, the header compression procedure in the third embodiment is adopted, that is, the relay node sends the received IP packets sent by UE1 and UE2 to the eNodeB entity directly. At this time, no compression context is established between the UEs and the relay node; a context for a compression profile of the IP/UDP/GTP-U header is established between the relay node and the eNodeB; and a context for a compression profile of the IP/UDP/App. header is established between UE1 and UE2 and the eNodeB. The frame structure of the compressed IP header transmitted between the UE and the relay node is as shown in FIG. 6b; and the IP packets of this frame structure are sent to the eNodeB entity directly by the relay node.

The frame structure of the compressed IP header for which the context for two nested layers of ROHC compression is established between the relay node and the eNodeB is as shown in FIG. 6c, where the IP/UDP/App. header is the header compressed by the UE entity and directly forwarded by the relay node, and the IP/UDP/GTP-U header is the header encapsulated by the relay node.

When decompressing the encapsulated data packets sent by UE1 and UE2, the eNodeB distinguishes the data packets by using the identifiers of the data sent by UE1 and UE2, where the identifiers of the data packets may be IP addresses, port numbers, user identities, header compression context identifiers, and so on.

In the implementation of this embodiment, the embodiment may also be implemented between the UE and the relay node according to the method described in the embodiment corresponding to FIG. 3, that is, the compressed IP/UDP/App. headers sent by the UEs are decompressed on the relay node; and then, when the relay node sends the data packets, compression is performed according to the compression method of this embodiment, as shown in the frame structures of FIG. 6b and FIG. 6c.

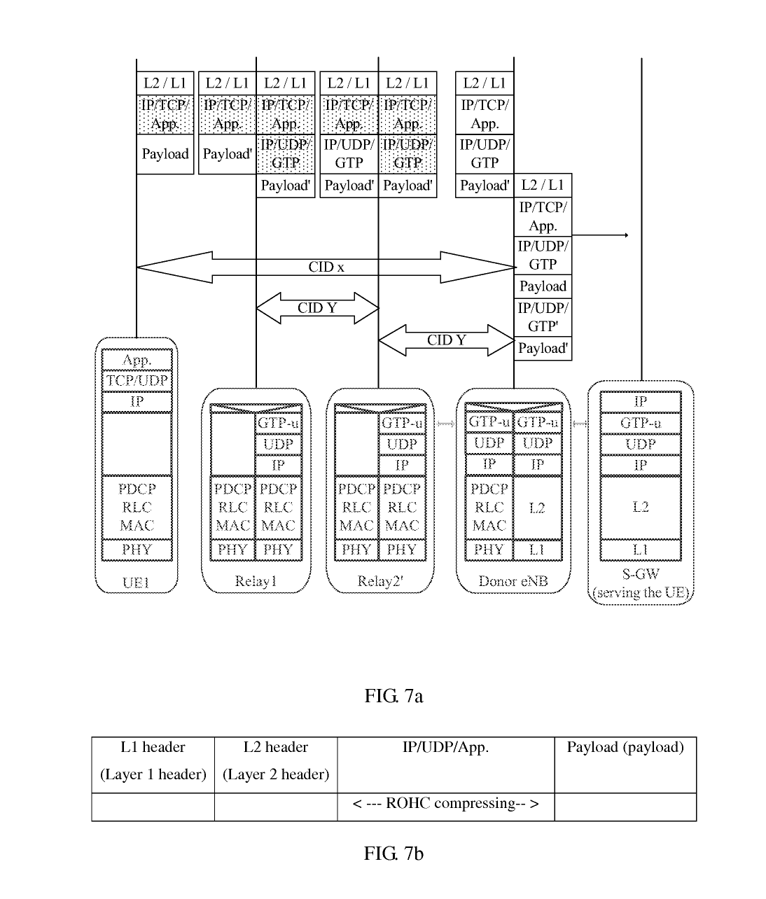

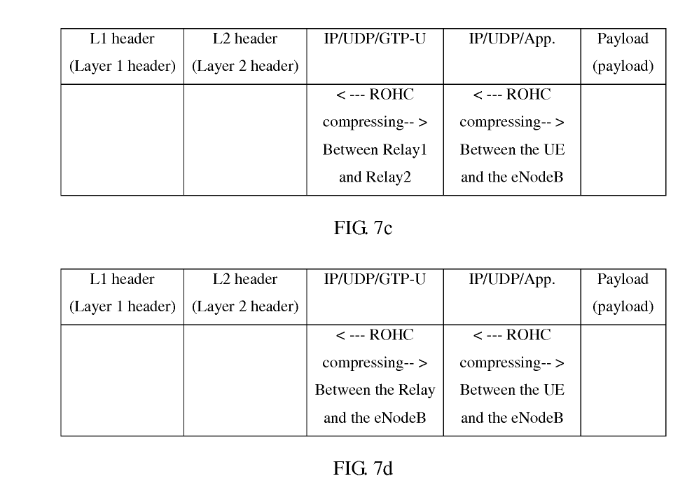

FIG. 7a is a schematic diagram of another method for header compression in a network relay scenario according to an embodiment of the present invention. In order to clearly distinguish a compressed part from a decompressed part, the dotted shade is used in the drawing to represent a compressed part.

In this embodiment, under the circumstance where there are multiple relay nodes between the UE and the eNodeB, the data packets sent by the UE are sent to the eNodeB via relay node 1 and relay node 2 as shown in the drawing. In this embodiment, both relay node 1 relay node 2 send the received header-compressed data packets sent by the UE, to the eNodeB directly.

In this embodiment, header compression is performed for the IP/UDP/App. header of the data packet sent by the UE to relay node 1 and then the data packet is sent by relay node 1 to relay node 2 directly; and meanwhile, relay node 1 encapsulates the IP/UDP/GTP-U header in the data packet, and performs the compression of the header compression profile for the IP/UDP/GTP-U header.

Relay node 2 receives the compressed data packet sent by relay node 1 and decompresses the compressed IP/UDP/GTP-U header; encapsulates the IP/UDP/GTP-U header in the IP packet sent to the eNodeB, and performs the compression of the header compression profile for the IP/UDP/GTP-U header.

The compressed data packet received by the eNodeB entity from relay node 2 is encapsulated with the compressed IP/UDP/App. header, and the IP/UDP/GTP-U header compressed by relay node 2. The eNodeB entity decompresses the IP/UDP/App. header compressed by the UE and the IP/UDP/GTP-U header compressed by relay node 2, and sends the data packet to a next entity.

In this embodiment, the context for compressing the IP/UDP/GTP-U header is established between the UE and the eNodeB in case of forwarding by multiple relay nodes; the context for compressing the IP/UDP/GTP-U header is established between relay node 1 and relay node 2; and the context for compressing the IP/UDP/GTP-U header is established between relay node 2 and the eNodeB entity. The frame structure of the compressed IP header transmitted between the UE and the relay nodes is as shown in FIG. 7b.

The frame structure of the compressed IP header for which the context for two nested layers of ROHC compression is established between relay node 1 and relay node 2 is as shown in FIG. 7c, where the IP/UDP/App. header is the header compressed by the UE entity and directly forwarded by the relay node, and the IP/UDP/GTP-U header is the header encapsulated by the relay node.

The frame structure of the compressed IP header for which the context for two nested layers of ROHC compression is established between relay node 2 and the eNodeB entity is as shown in FIG. 7d, where the IP/UDP/App. header is the header compressed by the UE entity and directly forwarded by the relay node, and the IP/UDP/GTP-U header is the header encapsulated by the relay node.

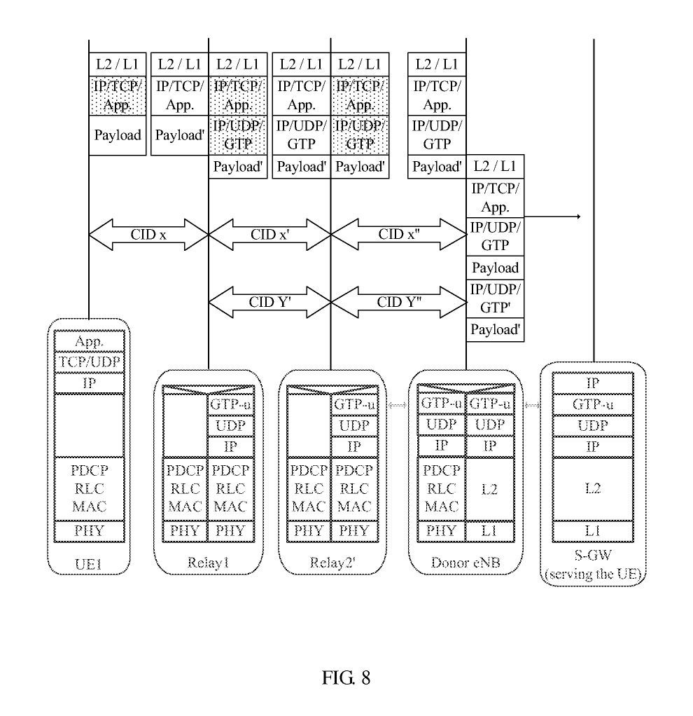

FIG. 8 is a schematic diagram of another method for header compression in a network relay scenario according to an embodiment of the present invention. In order to clearly distinguish a compressed part from a decompressed part, the dotted shade is used in the drawing to represent a compressed part.

In this embodiment, under the circumstance where there are multiple relay nodes between the UE and the eNodeB, a data packet sent by the UE is sent to the eNodeB via relay node 1 and relay node 2. In this embodiment, both relay node 1 and relay node 2 send the received header-compressed data packet sent by the UE, to the eNodeB directly.

In this embodiment, the UE performs header compression for the IP/UDP/App. header of the data packet sent by the UE to relay node 1, and after receiving the data packet, the intermediate entity 1 decompresses the compressed IP/UDP/App. header; the relay node encapsulates the IP/UDP/GTP-U header in the data packet, compresses the IP/UDP/App. header and the IP/UDP/GTP-U header respectively, and sends the data packet to relay node 2.

Relay node 2 receives the compressed data packet sent by relay node 1 and decompresses the compressed IP/UDP/App. header and IP/UDP/GTP-U header respectively; encapsulates the IP/UDP/GTP-U header in the IP packet sent to the eNodeB, and performs the compression of the header compression profile for the IP/UDP/App. header and the IP/UDP/GTP-U header.

The compressed data packet received by the eNodeB from relay node 2 is encapsulated with the compressed IP/UDP/App. header, and the IP/UDP/GTP-U header compressed by relay node 2. The eNodeB entity decompresses the IP/UDP/App. header compressed by the UE and the IP/UDP/GTP-U header compressed by relay node 2, and sends the data packet to a next entity.

In this embodiment, a context for compressing the IP/UDP/GTP-U header is established between the UE and relay node 1; a context for compressing the IP/UDP/GTP-U header is established between relay node 1 and relay node 2; and a context for compressing the IP/UDP/GTP-U header is established between relay node 2 and the eNodeB; a context for compressing the IP/UDP/GTP-U header is established between relay node 1 and relay node 2. The frame structure of the compressed IP header transmitted between the UE and the relay nodes is as shown in FIG. 7b.

The frame structure of the compressed IP header for which the context for two nested layers of ROHC compression is established between relay node 1 and relay node 2 is as shown in FIG. 7c, where the IP/UDP/App. header is the header compressed by the UE entity and directly forwarded by the relay node, and the IP/UDP/GTP-U header is the header encapsulated by the relay node.

The frame structure of the compressed IP header for which the context for two nested layers of ROHC compression is established between relay node 2 and the eNodeB entity is as shown in FIG. 7d, where the IP/UDP/App. header is the header compressed by the UE entity and directly forwarded by the relay node, and the IP/UDP/GTP-U header is the header encapsulated by the relay node.

The IP/UDP/GTP-U header compression profile involved in the foregoing method embodiment is described below, which specifically includes the following:

In a GTP-U General Packet Radio Service Tunneling Protocol-User Plane data packet defined by 3GPP, the encapsulated header includes the following information:
GTP version (“001”) GTP version
PT flag (“1”)—protocol type protocol type
Extension Header flag (“1”) extension header flag
Sequence Number flag (“1”) sequence number flag
Message Type (“00000000”) message type
N-PDU number flag (“1”)—Network-Protocol Data Unit flag
TEID (“00000000”) tunnel identifier
Sequence Number (“000000001”) sequence number

The Sequence Number parameter is a monotonically increasing variable parameter, and other parameters are parameters that remain unchanged during the transmission of the GTP-U data packet. According to the ROHC compression architecture, the unchanged parameters are saved as a state on the compressor and the decompressor, that is, the information to be used when compression and decompression are performed; and the corresponding variable parameters are encapsulated in the compressed GTP-U header.

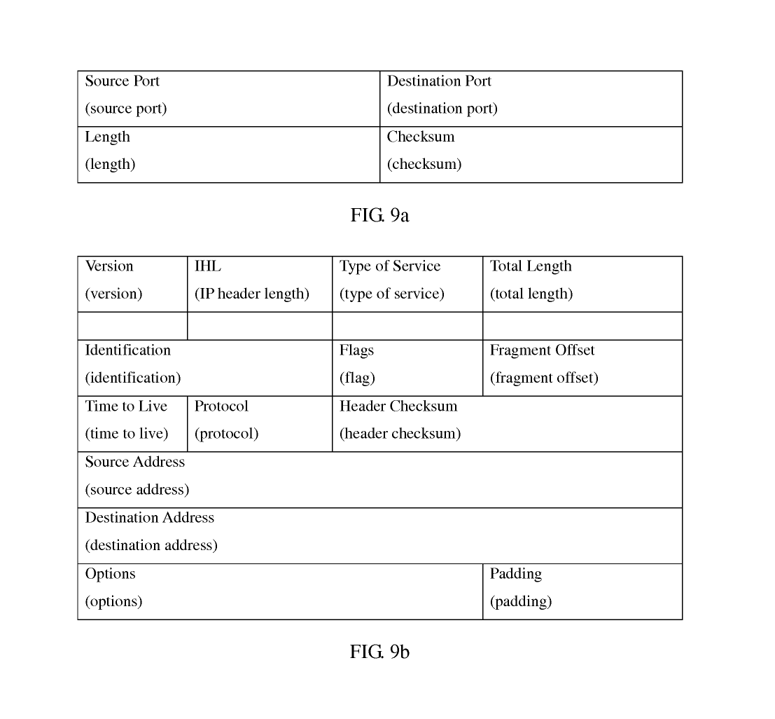

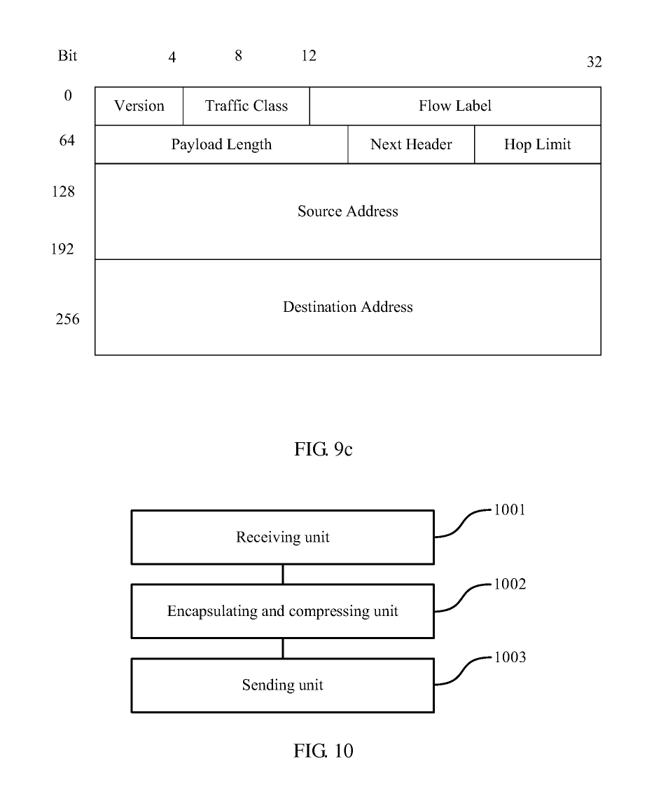

The UDP protocol is used for bearing the GTP-U protocol header, and the frame structure of the UDP packet is as shown in FIG. 9a, where, Source Port and Destination Port are unchanged parameters during the transmission of multiple data packets, and may be saved as a state on the compressor and the decompressor performing the compression profile.

The frame structure of the IPv4 header is as shown in FIG. 9b, where Version, Type of Service, Source Address, Destination Address, and Offset are unchanged parameters during the transmission of multiple data packets, and may be saved as a state on the compressor and the decompressor performing the compression profile.

The frame structure of the IPv6 header is as shown in FIG. 9c, where the static header of the IPv6 data packet includes version, Flow Label, Source Address, and Destination Address; and the dynamically changing address includes Traffic Class, Hop Limit, Next Header, and Payload Length. Therefore, when the IPv6 header is being compressed, the static part may be used as the part of the header that is compressed by using the header compression method.

The static part of the foregoing IP header may be compressed by the basic compression method as the header compression profile (such as ROHC compression). For the non-static header part, the compression profile includes other optimization methods, for example, the method for predicating the header content may compress a part of non-static headers.

To sum up, under the circumstance where there is a relay node between the UE and the network and the interface between the relay node and the network is still a radio interface, in addition to being capable of processing the header-compressed data packets sent by the UE, the relay node still needs to face the problem of saving the air interface bandwidth between the relay node and the eNodeB, and the header compression of the data packets between the relay node and the eNodeB entity. The air interface transport protocol between the relay entity and the eNodeB uses different protocol stacks; different respective header compressions are used on the two air interfaces; and it is necessary to coordinate the nesting of respective compression profiles and to maintain the context between the compressor and the decompressor. By using the method provided in the foregoing embodiments of the present invention, the problem that the IP packets occupy too much bandwidth in a network relay scenario is solved effectively; and by applying the ROHC compression mechanism on the relay node, the eNB, and the UE, the function of compressing IP headers is solved and implemented; the occupation of air interface bandwidth is reduced; and the spectrum utilization is improved.

Persons of ordinary skill in the art may understand that all or part of steps in the foregoing embodiments may be implemented by a program instructing relevant hardware. The program may be stored in a computer readable storage medium, which may be a ROM, a RAM, a magnetic disk, and an optical disk.

FIG. 10 shows a relay node according to an embodiment of the present invention, which includes:

a receiving unit 1001, configured to receive a first header-compressed data packet sent by user equipment or another relay node;

an encapsulating and compressing unit 1002, configured to encapsulate a transport protocol header for the first data packet, and perform header compression for the header to form a second data packet; and

a sending unit 1003, configured to send the second data packet to an eNodeB or a next relay node.

The encapsulating and compressing unit 1002 is specifically configured to:

after decompressing the header of the first data packet, compress the decompressed header of the first data packet respectively by respectively using an IP/UDP/APP. compression profile and an IP/UDP/GTP-U compression profile, to respectively form the second data packet having two segments of compressed headers; or compress the IP/UDP/APP. header and the IP/UDP/GTP-U header into one segment of compressed headers to form the second data packet.

Alternatively, an IP/UDP/GTP-U header is encapsulated outside the IP/UDP/APP. header of the first header-compressed data packet, to form the second data packet.

The relay node provided in this embodiment can implement the functions of the relay nodes in all the foregoing method embodiments of the present invention, and further implement the methods provided in the embodiments. Thereby, the problem that the IP packets occupy too much bandwidth in a network relay scenario is solved; and by applying the ROHC compression mechanism on the relay node, the eNB, and the UE, the function of compressing IP headers is solved and implemented; the occupation of air interface bandwidth is reduced; and the spectrum utilization is improved.

It should be particularly noted that, all or part of the above units may be implemented by being integrated into a chip. The functional units in the embodiments of the present application may be integrated into one processing module, or each unit may physically exist separately, or two or more units may be integrated into one module. The above integrated module may be implemented in the form of hardware or in the form of a software functional module. When being implemented in the form of a software functional module and being sold or used as an independent product, the above integrated module may also be stored in a computer readable storage medium. The storage medium may be a read only memory, a magnetic disk, and an optical disk.

The drawings and the relevant descriptions are only used to illustrate the principle of the present invention, and are not intended to limit the protection scope of the present invention. For example, the message names and entities in the embodiments of the present application may vary according to the network, and some messages may also be omitted. Therefore, any modification, equivalent replacement, and improvement made without departing from the spirit and principle of the present application shall fall within the protection scope of the present invention.

Although the present application has been illustrated and described with reference to some exemplary embodiments of the present invention, persons of ordinary skill in the art shall appreciate that various modifications in form or in detail may be made without departing from the spirit and scope of the present invention.

1. A method for header compression in a network relay scenario, the method comprising:
receiving, by a relay node, a first header-compressed data packet sent by user equipment or another relay node;
encapsulating a transport protocol header for the first header-compressed data packet and performing header compression for the transport protocol header to form a second data packet; and
sending the second data packet to an eNodeB or a next relay node in an uplink direction.

2. The method according to claim 1, wherein the transport protocol used for encapsulating the transport protocol header comprises a tunneling protocol and a transport protocol for the tunneling protocol, wherein the tunneling protocol comprises general packet radio service tunneling protocol-user plane (GTP-U).

3. The method according to claim 1, wherein encapsulating the transport protocol header for the first header-compressed data packet and performing header compression for the transport protocol header to form the second data packet comprise:
decompressing a header of the first header-compressed data packet to obtain an Internet Protocol/User Datagram Protocol/Application Protocol (IP/UDP/APP.) header;
encapsulating the decompressed first data packet with an Internet Protocol/User Datagram Protocol/General Packet Radio Service Tunneling Protocol-User Plane (IP/UDP/GTP-U) header; and
compressing the IP/UDP/APP. header by using an IP/UDP/APP. compression profile and compressing the IP/UDP/GTP-U header by using an IP/UDP/GTP-U compression profile to form the second data packet having two segments of compressed headers; or compressing the IP/UDP/APP. header and the IP/UDP/GTP-U header to form the second data packet having one segment of compressed headers.

4. The method according to claim 3, further comprising:
receiving, by the relay node, a first robust IP header compression (ROHC) parameter sent by the user equipment and used for the first data packet; and
sending, by the relay node, a first packet data convergence protocol (PDCP) parameter supported by the relay node to the user equipment, wherein the first PDCP parameter comprises the first ROHC parameter;
wherein decompressing the header of the first header-compressed data packet comprises decompressing, by the relay node, the header of the first header-compressed data packet according to the first ROHC parameter; and
wherein, after the decompressing the header of the first header-compressed data packet, the method further comprises:
sending, by the relay node, a second ROHC parameter for the second data packet to the eNodeB, so that the eNodeB decompresses the header of the second data packet according to the second ROHC parameter, wherein the second ROHC parameter comprises a profile used by the relay node for compressing the header of the second data packet; and
receiving, by the relay node, a second PDCP parameter sent by the eNodeB and supported by the eNodeB, wherein the second PDCP parameter comprises the second ROHC parameter.

5. The method according to claim 4, wherein:
when the second data packet having two segments of compressed headers is formed, the second ROHC parameter comprises an IP/UDP/APP. compression profile and an IP/UDP/GTP-U compression profile; and
when the second data packet having one segment of compressed headers is formed, the ROHC parameter comprises a compression profile corresponding to the IP/UDP/APP. header and the IP/UDP/GTP-U header.

6. The method according to claim 16, wherein receiving, the first header-compressed data packet comprises receiving, by the relay node, the first header-compressed data packet, which is sent by the user equipment and encapsulated with an IP/UDP/APP. header that has undergone header compression; and
wherein encapsulating the transport protocol header for the first header-compressed data packet, and performing header compression for the transport protocol header comprise encapsulating an IP/UDP/GTP-U header outside the IP/UDP/APP. header of the first header-compressed data packet, and performing header compression for the IP/UDP/GTP-U header.

7. The method according to claim 6, further comprising:
receiving, by the relay node, a third ROHC parameter sent by the user equipment and used for the first header-compressed data packet;
forwarding, by the relay node, the third ROHC parameter to the eNodeB;
sending, by the relay node, a fourth ROHC parameter for the second data packet to the eNodeB, so that the eNodeB decompresses the header of the second data packet according to the third ROHC parameter and the fourth ROHC parameter, wherein the fourth ROHC parameter comprises a profile used by the relay node for compressing the header of the second data packet;
receiving, by the relay node, a PDCP parameter sent by the eNodeB and supported by the eNodeB, wherein the PDCP parameter comprises the third ROHC parameter and the fourth ROHC parameter; and
forwarding, by the relay node, the PDCP parameter supported by the eNodeB to the user equipment.

8. The method according to claim 6, further comprising:
receiving, by the relay node, a fifth ROHC parameter sent by the user equipment and used for the first data packet;
sending, by the relay node, a third PDCP parameter supported by the relay node to the user equipment, wherein the third PDCP parameter comprises the fifth ROHC parameter;
forwarding, by the relay node, the fifth ROHC parameter to the eNodeB;
sending, by the relay node, a sixth ROHC parameter for the second data packet to the eNodeB, so that the eNodeB decompresses the header of the second data packet according to the fifth ROHC parameter and the sixth ROHC parameter, wherein the sixth ROHC parameter comprises a profile used by the relay node for compressing the header of the second data packet; and
receiving, by the relay node, a fourth PDCP parameter sent by the eNodeB and supported by the eNodeB, wherein the fourth PDCP parameter comprises the fifth ROHC parameter and the sixth ROHC parameter.

9. The method according to claim 8, wherein the fifth ROHC parameter comprises an IP/UDP/APP. compression profile and the sixth ROHC parameter comprises an IP/UDP/GTP-U compression profile.

10. The method according to claim 17, wherein receiving, the first header-compressed data packet comprises receiving, by the relay node, the first header-compressed data packet, which is sent by another relay node and encapsulated with an IP/UDP/APP. header and an IP/UDP/GTP-U header that have undergone header compression;
wherein encapsulating the transport protocol header for the first header-compressed data packet, and performing header compression for the transport protocol header to form the second data packet comprise:
decompressing the IP/UDP/APP. header and the IP/UDP/GTP-U header of the first header-compressed data packet; compressing the IP/UDP/APP. header by using an IP/UDP/APP. compression profile, and compressing the IP/UDP/GTP-U header by using an IP/UDP/GTP-U compression profile to form the second data packet having two segments of compressed headers, or compressing the IP/UDP/APP. header and the IP/UDP/GTP-U header to form the second data packet having one segment of compressed headers; or
decompressing the IP/UDP/GTP-U header of the first header-compressed data packet; and compressing the IP/UDP/GTP-U header by using the IP/UDP/GTP-U compression profile to form the second data packet having two segments of compressed headers, wherein the two segments of compressed headers comprise: the IP/UDP/APP. header and the IP/UDP/GTP-U header.

11. The method according to claim 16, wherein receiving, the first header-compressed data packet comprises receiving multiple first header-compressed data packets sent by multiple user equipment;
wherein encapsulating the transport protocol header for the first header-compressed data packet, and performing header compression for the transport protocol header to form the second data packet comprise encapsulating a same transport protocol header for the headers of the multiple first header-compressed data packets, and performing header compression for the transport protocol header to form a second data packet.

12. The method according to claim 11, wherein the second data packet is encapsulated with IP addresses and/or port numbers, wherein the IP addresses and/or port numbers correspond respectively to the multiple user equipment and distinguish data packets that are sent by the multiple user equipment and are encapsulated with the same transport protocol header.

13. A relay node, comprising:
a receiving unit, configured to receive a first header-compressed data packet sent by user equipment or another relay node;
an encapsulating and compressing unit, configured to encapsulate a transport protocol header for the first header-compressed data packet received by the receiving unit, and to perform header compression for the transport protocol header to form a second data packet; and
a sending unit, configured to send the second data packet encapsulated by the encapsulating and compressing unit to an eNodeB or a next relay node in an uplink direction.

14. The relay node according to claim 13, wherein the encapsulating and compressing unit is configured to:
decompress a header of the first data packet to obtain an Internet Protocol/User Datagram Protocol/Application Protocol, IP/UDP/APP., header,
encapsulate the decompressed header of the first header-compressed data packet with an Internet Protocol/User Datagram Protocol/General Packet Radio Service Tunneling Protocol-User Plane, IP/UDP/GTP-U, header; and
compress the IP/UDP/APP. header by using an IP/UDP/APP. compression profile and compress the IP/UDP/GTP-U header by using an IP/UDP/GTP-U compression profile to form the second data packet having two segments of compressed headers; or compress the IP/UDP/APP. header and the IP/UDP/GTP-U header to form the second data packet having one segment of compressed headers.

15. The relay node according to claim 13, wherein the encapsulating and compressing unit is configured to encapsulate an IP/UDP/GTP-U header outside an IP/UDP/APP. header of the first header-compressed data packet to form the second data packet, and performing header compression for the IP/UDP/GTP-U header.

16. The method according to claim 1, wherein the receiving comprises receiving a first header-compressed data packet sent by user equipment.

17. The method according to claim 1, wherein the receiving comprises receiving a first header-compressed data packet sent by another relay node.
